(19) United States
(12) Patent Application Publication
(10) Pub. No.: US 2009/0314814 A1
(43) Pub. Date: Dec. 24, 2009

(54) VEHICLE RACK FOR HOLDING HOCKEY STICKS

(76) Inventor: Michael ROSS, Oakhorst, NJ (US)

Correspondence Address: Diane Dunn McKay, Esq.;Mathews, Shepherd, McKay & Bruneau, P.A., Suite 201, 29 Thanet Road, Princeton, NJ, 08540, US

(21) Appl. No.: 12/141,467

(22) Filed: Jun. 18, 2008

(51) Int. Cl. B60R 9/08

(52) U.S. Cl. 224/315; 224/324; 224/562; 224/321

(57) ABSTRACT

The invention relates to a vehicle rack for holding hockey sticks including a rack with a base. A lower cushion bar is attached to an upper surface of the base. A clamping arm is pivotally coupled to a lock bracket extending upwardly from the base. An upper cushion bar is attached to a lower surface of the clamping arm. The clamping arm is pivotably moveable between an open position to receive one or more hockey sticks and a closed position for clamping the received hockey sticks between the lower cushion bar and the upper cushion bar. A latch downwardly extends from an end of the clamping arm in the closed position. The latch aligns with the base. The locking bracket and the latch can have a similar shape in order to maintain the lower cushion bar and upper cushion bar in a parallel relationship to one another in the closed position. The rack can be attached to the roof of a vehicle with one or more magnets attached to the base.

### BACKGROUND OF THE INVENTION

1. Field of the Invention

The present invention relates to a vehicle roof carrier for carrying hockey sticks in which the rack includes an expeditiously openable rack with holding means for clamping the dimensions of received hockey sticks and is removably attached to the vehicle while providing stability during movement of the vehicle.

2. Description of Related Art

Carriers for hockey sticks are known. U.S. Pat. No. 3,880,336 describes a hand-liftable carrier for pairs of hockey sticks. The hockey sticks are securable above a plate between U-shaped rods. The U-shaped rods can be hand-lifted.

U.S. Pat. No. 6,431,627 describes a rack suitable for carrying and storing hockey sticks having an inverted U-shaped frame. A pair of latching arms is hinged to the frame on either side of a vertical leg. The latching arms provide movement between an open position wherein the sticks can be mounted upon a supporting member horizontally aligned with the vertical leg and a closed position wherein the latching arms closes against the support members to capture the sticks in the frame.

Several patents describe ski racks for allowing skis and snowboards to be attached to a roof of a vehicle. U.S. Pat. No. 6,431,421 describes a fixed support assembly securable to a roof of a vehicle being composed of a pair of opposed tracks in a parallel orientation. A sliding support is slidably coupled to the opposed tracks. A ski support is secured to the sliding support.

U.S. Pat. No. 5,312,030 describes a ski rack magnetically attached to a roof of a motor vehicle. A flexible plate made of magnetic material having the shape of the roof is fitted to the roof. A metal base plate is glued to the magnetic plate. On the base plate a ski rack unit is screwed. The ski rack includes seats in order to receive a respective pair of skis. A vibration damping support is located at the four corners spaced from the center of the flexible base plate.

While these devices fulfill their respective objectives, the aforementioned patents do not describe a roof top carrier which can be used for carrying hockey sticks. The thickness of the hockey sticks do not allow them to be carried in conventional ski racks for holding skis and snow boards which are much thinner and also have a cumbersome arrangement for holding the skis. It is desirable to provide a roof top carrier for hockey sticks which is compact and provides easy loading of hockey sticks while not being compromised during movement at higher speeds of the vehicle and can be manufactured at low cost.

### SUMMARY OF THE INVENTION

The invention relates to a vehicle rack for holding hockey sticks including a rack with a base. A lower cushion bar is attached to an upper surface of the base. A clamping arm is pivotally coupled to a lock bracket extending upwardly from the base. An upper cushion bar is attached to a lower surface of the clamping arm. The clamping arm is pivotably moveable between an open position to receive one or more hockey sticks and a closed position for clamping the received hockey sticks between the lower cushion bar and the upper cushion bar.

A latch downwardly extends from an end of the clamping arm in the closed position. The latch aligns with the base. The locking bracket and the latch can have a similar shape in order to maintain the lower cushion bar and upper cushion bar in a parallel relationship to one another in the closed position. A locking means can be used to retain the clamping arm in a closed and locked position.

An attachment means attaches the rack to a roof of a vehicle. The attachment means can be one or more magnets. The magnets can be attached to the base with a shock resistant arm for allowing movement of the arm during wind or vehicle movements.

The invention will be more fully described by reference to the following drawings.

### BRIEF DESCRIPTION OF THE DRAWINGS

FIG. 1 is a schematic diagram of the vehicle rack for holding hockey sticks in a closed position in accordance with the teachings of the present invention.

FIG. 2 is a schematic diagram of the vehicle rack for holding hockey sticks in an open position.

FIG. 3 is a left side view of the vehicle rack for holding hockey sticks shown in FIG. 1.

FIG. 4 is a top plan view of the attachment means shown in FIG. 1.

FIG. 5A is a front elevational view of a lock bracket used in FIG. 1.

FIG. 5B is a right side view of the lock bracket.

FIG. 6A is a front elevational view of a latch used in FIG. 1.

FIG. 6B is a left side view of the latch.

FIG. 6C is a top plan view of the latch.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

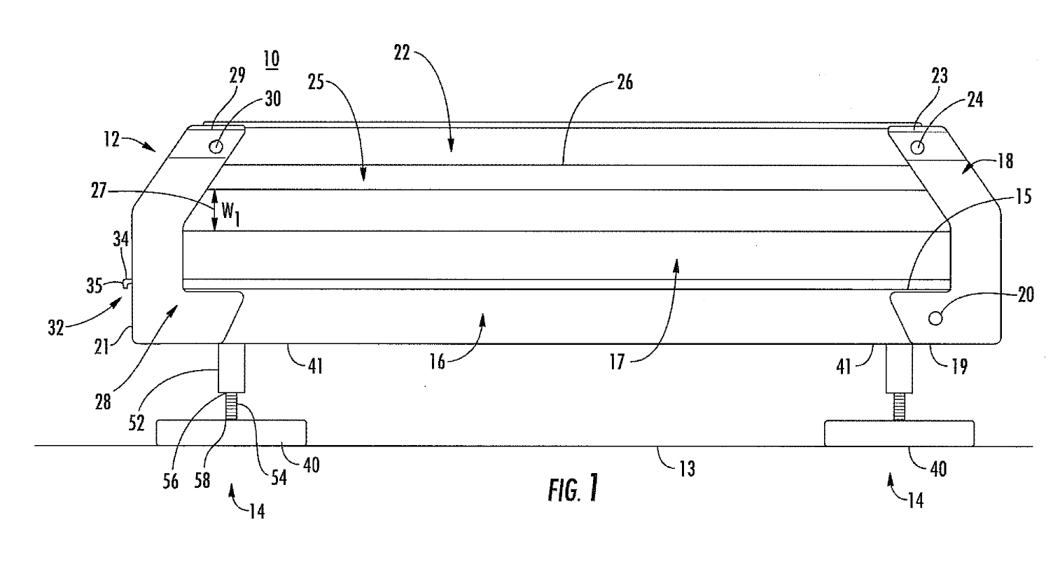

FIGS. 1-4 illustrate a vehicle rack for holding hockey sticks 10 in accordance with the teachings of the present invention. Vehicle rack for holding hockey sticks 10 includes rack 12 and attachment means 14. Attachment means 14 can be adapted for removably attaching rack 12 to a roof of vehicle 13. Rack 12 includes base 16 extending in a substantially horizontal direction parallel to the roof of vehicle 13. Lower cushion bar 17 is attached to upper surface 15 of base 16. Lock bracket 18 is positioned at end 19 of base 16. Lock bracket 18 extends upwardly from base 16. Lock bracket 18 can be attached to base 16 using coupling 20. For example, coupling 20 can be a screw. Alternatively, lock bracket 18 can be formed integral with base 16 in a one piece construction.

Clamping arm 22 is pivotably attached to end 23 of lock bracket 18. For example, clamping arm 22 can be attached to lock bracket 18 with pivot pin 24. Upper cushion bar 25 is attached to lower surface 26 of clamping arm 22. Lower cushion bar 17 and upper cushion bar 25 can be made of a semi flexible material such as rubber or plastic. Clamping arm 22 is movable between a closed position as shown in FIG. 1 and an open position as shown in FIG. 2.

Gap 27 is positioned between lower cushion bar 17 and upper cushion bar 25. In the closed position, gap 27 can have a width W₁ which is substantially the same as the width of a conventional hockey stick. For example, gap 27 can have a width in the range of about ½″ to about ¾ inches.

Latch 28 is positioned at end 29 of clamping arm 22, as shown in FIG. 2. Latch 28 can be attached to clamping arm 22 with coupling 30. For example, coupling 30 can be a screw. Alternatively, latch 28 can be formed integral with clamping arm 22 in a one piece construction. Locking means 32 locks latch 28 and clamping arm 22 in a closed and locked position.

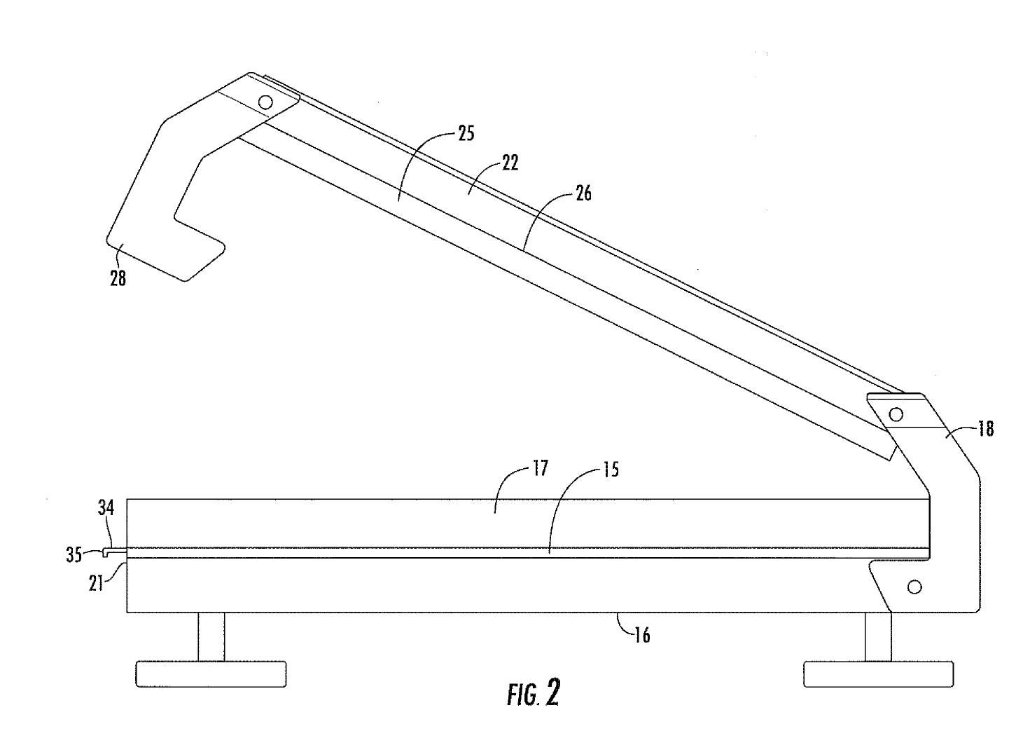

In one embodiment, locking means 32 comprises protrusion 34 extending from end 21 of base 12. Protrusion 34 includes downwardly extending foot 35. During loading of clamping arm 22, foot 35 is received in aperture 37 formed in side 38 of latch 28, as shown in FIG. 3. During operation of vehicle rack for holding hockey sticks 10, rack 12 is placed in an open position by upwardly moving clamping arm 22. One or more hockey sticks (not shown) are placed between lower cushion bar 17 and upper cushion bar 25 within gap 27. Clamping bar 17 is closed by downwardly moving clamping arm 22. In the closed position, lower cushion bar 17 and upper cushion bar 25 contact the received hockey sticks for clamping the received hockey sticks within rack 12. In the closed position, foot 35 is received within aperture 37 for locking clamping arm 22 to base 16.

In one embodiment, attachment means 14 comprises a pair of magnets 40, as shown in FIG. 1. Magnets 40 are mounted to bottom surface 41 of base 16. Protective cover 42 can be attached to or formed on outside surface 43 of magnets 40, as shown in FIGS. 4A-4B. Suitable materials for protective cover 42 include plastic or rubber. Magnets 40 have a size suitable for providing sufficient magnetic force to hold rack 12 on the roof of vehicle 13. Magnets 40 can be expeditiously removed by hand by applying a sufficient upward force. Suitable magnets apply a magnetic force in the range of about 70 lbs. to about 100 lbs., and preferably have a magnetic force of about 75 lbs. to about 80 lbs. For example, magnets 40 can have a circular shape having a diameter in the range of about two inches to about six inches and preferably have a diameter of about 3 inches.

Shock mount means 50 can attach magnets 40 to base 16. Shock mount means 50 includes mounting arm 52 coupled to shock resistant arm 54. Mounting arm 52 is coupled or integral with bottom surface 41 of base 16. Upper surface 56 of shock resistant arm 54 is attached to mounting arm 52 and lower surface 58 of shock resistant arm 54 is attached to magnets 40. Shock resistant arm 54 can be attached to center 44 of magnets 40. Shock resistant arm 54 can be formed of a semi-flexible synthetic material, such as, for example, a rubber gasket, to allow movement of shock resistant arm 54 from wind or vehicle movements during operation of the vehicle.

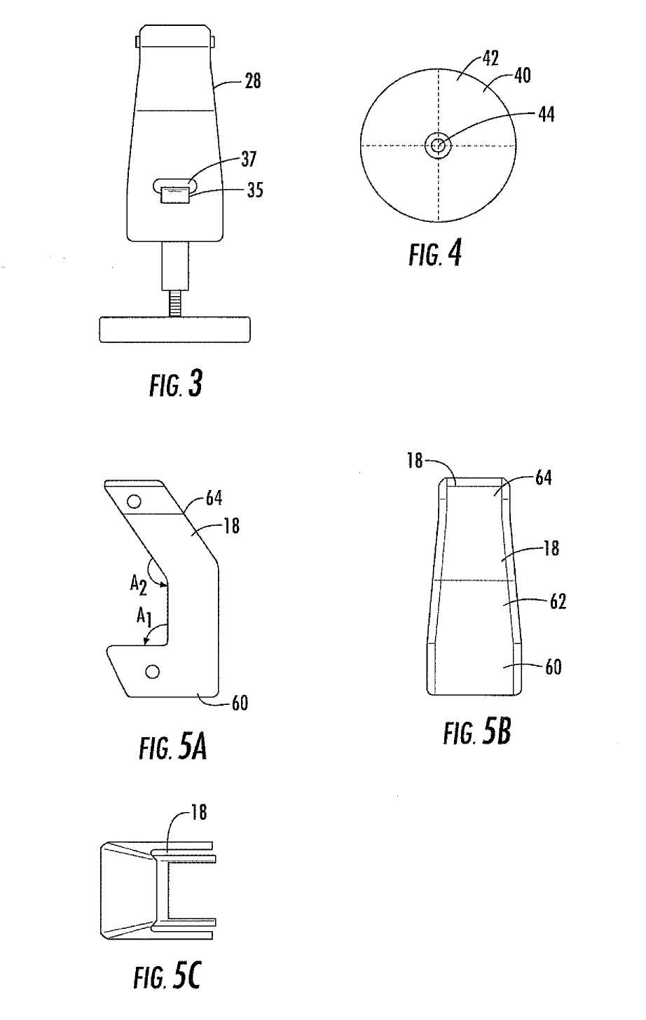

FIGS. 5A-5C illustrate lock bracket 18. Base section 60 is angled from mid section 62 at an angle A₁. For example, angle A₁ is 90 degrees for providing stability of lock bracket 18. Top section 64 can be angled at angle A₂ from midsection 62. In one embodiment, angle A₂ is greater than angle A₁ to provide less wind resistance of lock bracket 19. For example, angle A₂ can have an angle of about 120 degrees.

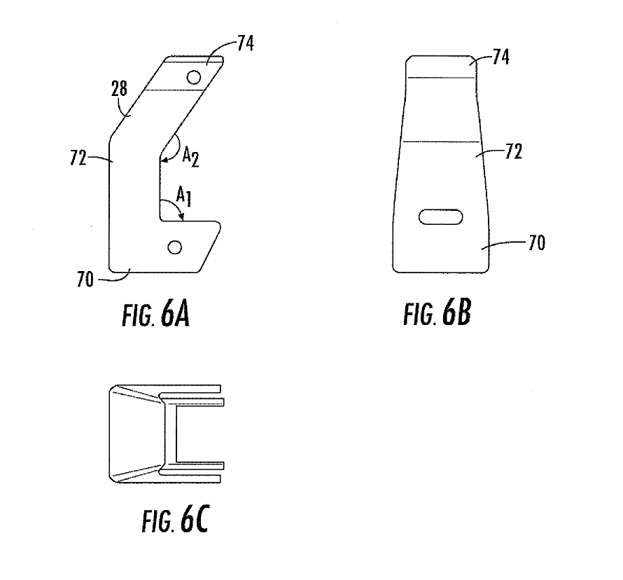

FIGS. 6A-6C illustrate latch 28. Base section 70 is angled from mid section 72 at angle A₁. Top section 74 is angled from mid section 72. Top section 74 can be angled at angle A₂. Accordingly, latch 28 has a similar shape to lock bracket 18 as a mirror image.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A vehicle rack for holding at least one hockey stick comprising:
a rack including a base;
attachment means attached to said base, said attachment means being adapted to attach to said base to the vehicle;
a lower cushion bar attached to an upper surface of said base;
a lock bracket extending upwardly from said base, said lock bracket having one end coupled to a first end of said base;
a clamping arm having a first end pivotally coupled to the other end of said bracket;
an upper cushion bar attached to a lower surface of said clamping arm; and
a latch coupled to a second end of said clamping arm,
wherein said clamping arm is pivotally movable between an open position adapted for receiving said at least one hockey stick between said lower cushion bar and said upper cushion bar and a closed position for aligning said latch with said base and clamping said received hockey sticks between said lower cushion bar and said upper cushion bar.

2. The vehicle rack of claim 1 wherein a gap is positioned between said lower cushion bar and said upper cushion bar, said gap has a width which is substantially the same as a width of said at least one hockey stick.

3. The vehicle rack of claim 1 further comprising locking means for locking said clamping arm to said base when said clamping arm is in said closed position.

4. The vehicle rack of claim 3 wherein said locking means comprises a protrusion extending from a second end of said base, said protrusion being received in an aperture formed in a side of said latch.

5. The vehicle rack of claim 4 wherein said protrusion includes a foot extending downwardly from said protrusion.

6. The vehicle rack of claim 1 wherein said attachment means comprises one or more magnets mounted to a bottom surface of said base.

7. The vehicle rack of claim 6 further comprising a protective cover over an outside surface of said one or more magnets.

8. The vehicle rack of claim 6 wherein each of said one or more magnets apply a magnetic force in the range of about 70 lbs to about 100 lbs.

9. The vehicle rack of claim 6 wherein each of said one or more magnets apply a magnetic force in the range of about 75 lbs to about 85 lbs.

10. The vehicle rack of claim 1 further comprising shock mount means for attaching said attachment means to said base.

11. The vehicle rack of claim 10 wherein said shock mount means comprises a mounting arm extending from a bottom surface of said base and a shock resistant arm extending between said mounting arm and an upper surface of said magnet, wherein said shock resistant arm is flexible.

12. The vehicle rack of claim 11 wherein said shock resistant arm is a rubber gasket.

13. The vehicle rack of claim 11 wherein said shock resistant arm is attached to a center of said magnet.

14. The vehicle rack of claim 1 wherein said lock bracket includes a base section coupled to said base and a mid section angled from said base section at an angle A₁, a top section of said lock bracket is angled from said midsection at an angle A₂, said angle A₂ is greater than said angle A₁.

15. The vehicle rack of claim 1 wherein said latch includes a base section coupled to said base and a mid section angled from said base section at an angle A₁, a top section of said latch is angled from said midsection at an angle A₂, said angle A₂ is greater than said angle A₁.

16. The vehicle rack of claim 1 wherein the locking bracket and the latch have a similar shape as a mirror image of one another.

17. The vehicle rack of claim 1 wherein said lower cushion bar and said upper cushion bar are formed of rubber or plastic.
